(19) United States
(12) Patent Application Publication
(10) Pub. No.: US 2010/0250651 A1
(43) Pub. Date: Sep. 30, 2010

(54) DATA ACCESS METHOD FOR MAKING ASYNCHRONOUS REQUEST TO BLOCK DEVICE

(75) Inventors: Ming-Hao Bi, Tianjin (CN); Tom Chen, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INVENTEC CORPORATION, Taipei (TW)

(21) Appl. No.: 12/415,611

(22) Filed: Mar. 31, 2009

(51) Int. Cl. G06F 15/16; G06F 15/167

(52) U.S. Cl. 709/203; 709/213

(57) ABSTRACT

A data access method for making an asynchronous request to a block device is adapted to access a block device in a server end and perform corresponding processing according to a plurality of data access requests. The data access method includes the steps. A current request is received from a client. A virtual device of the block device is invoked. The current request is compared with a request queue storing a plurality of requests to be processed. The requests to be processed are selected from the request queue according to an access address of the current request. A request merging program is performed on the requests to be processed with adjacent access addresses and the current request to generate a merged request. The merged request is submitted to the request queue. The requests having low access capacities is merged, so as to improve the access efficiency of the block device.

### BACKGROUND OF THE INVENTION

1. Field of Invention

The present invention relates to a data access method, and more particularly, to a data access method for making an asynchronous request to a block device.

2. Related Art

A Linux operating system includes a character device and a block device. Access modes of the two types of devices are entirely different. The character device is accessed through character transfer, while the block device is accessed in a unit of block. The character device does not need buffering and is not operated in a fixed block size. The block device has corresponding buffer areas for access requests, so that a particular sequence may be selected to perform operations. The character device does not set any buffer space, and can thus be accessed directly. Besides, the character device may only be read in sequentially, while the block device may be accessed randomly. Though the block device may be accessed randomly, for mechanic devices such as magnetic disks, a magnetic head has to be moved around in a random access, which may affect the access performance of the magnetic disks.

Thereby, when a large number of data access requests take place, the data access performance of the block device is easily degraded due to discontinuous access addresses.

### SUMMARY OF THE INVENTION

Accordingly, the present invention is a data access method for making an asynchronous request to a block device, which is adapted to perform corresponding access processing according to a plurality of data access requests.

In order to achieve the above objective, a data access method for making an asynchronous request to a block device is provided. The method comprises the following steps. A current request is received from a client. A virtual device of the block device is invoked. The current request is compared with a request queue storing a plurality of requests to be processed. The corresponding requests to be processed are selected from the request queue according to an access address of the current request. A request merging program is performed on the requests to be processed with adjacent access addresses and the current request to generate a merged request. The merged request is submitted to the request queue.

In view of the above, an asynchronous processing method for data access requests is adapted to merge the data access requests for accessing the block device, such that the data access requests with continuous access addresses are merged into a single data access request, thereby enhancing the access efficiency of the block device.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of the present invention;

FIG. 2 is a schematic view of an operation flow of the present invention;

FIG. 3 is a schematic view of an operation flow of selecting requests to be processed; and

FIG. 4 is a schematic view of an operation flow of submitting a merged request to a request queue.

### DETAILED DESCRIPTION OF THE INVENTION

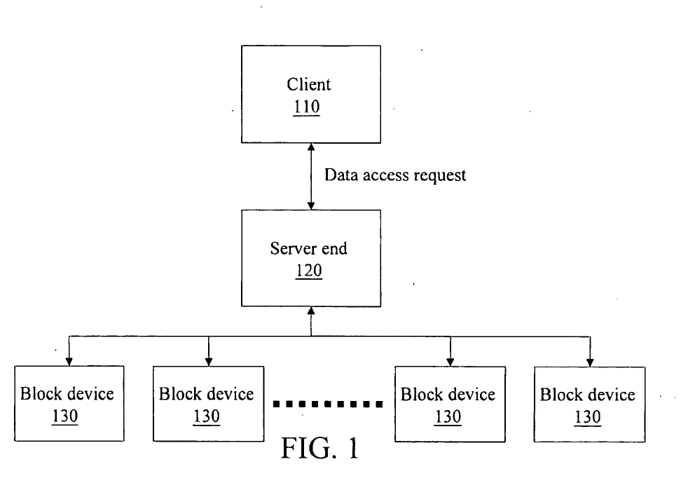

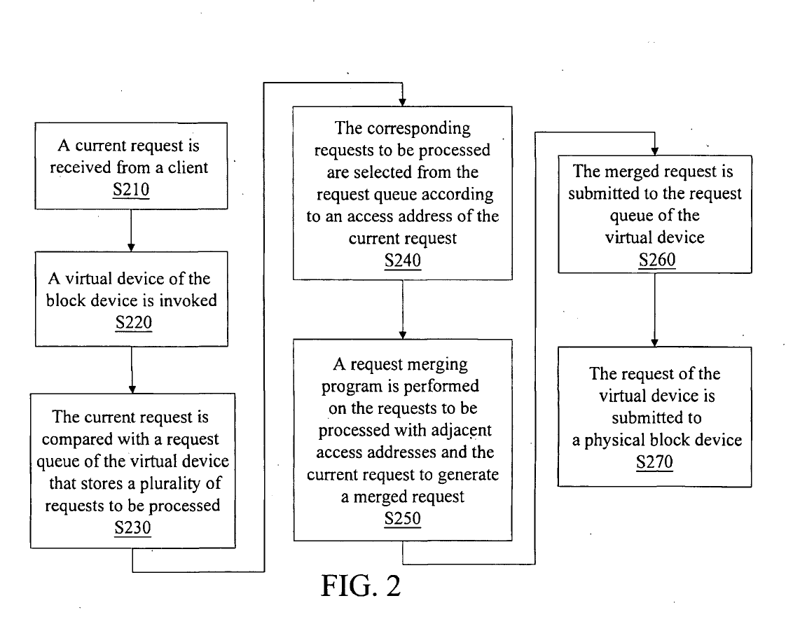

FIG. 1 is a schematic structural view of the present invention. The present invention comprises a client 110 and a server end 120. The server end 120 is electrically connected to a plurality of block devices 130. The server end 120 is electrically connected between the client 110 and the block devices 130, respectively. After being booted, the server end 120 creates a connecting relationship between the block device 130 and a virtual device. When receiving data access requests from the client 110, the server end 120 extracts corresponding data from the block device 130 according to access addresses of the data access requests. The server end 120 then processes the data access requests sequentially, and stores the received data access requests into a request queue. In order to improve the data access efficiency of the server end 120, the present invention provides the following method of processing data access requests. FIG. 2 is a schematic view of an operation flow of the present invention.

In Step S210, a current request is received from a client.

In Step S220, a virtual device of the block device is invoked.

In Step S230, the current request is compared with a request queue of the virtual device that stores a plurality of requests to be processed.

In Step S240, the corresponding requests to be processed are selected from the request queue according to an access address of the current request.

In Step S250, a request merging program is performed on the requests to be processed with adjacent access addresses and the current request to generate a merged request.

In Step S260, the merged request is submitted to the request queue of the virtual device.

In Step S270, the request of the virtual device is submitted to a physical block device.

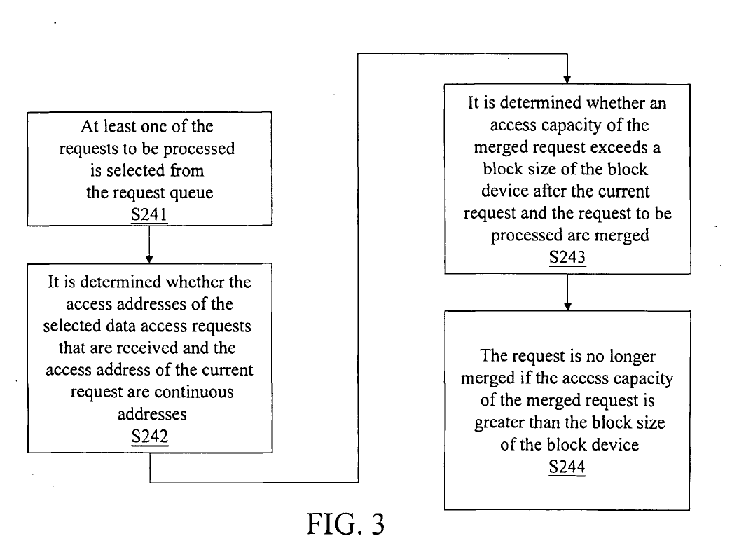

First, the client 110 sends the current request to the server end 120, so as to access data from the corresponding block device 130. Next, after obtaining the current request, the server end 120 compares access addresses of the current request and the requests to be processed stored in the request queue. In the present invention, the access addresses are selected according to the continuity of the access addresses and sequentiality of the data access requests. FIG. 3 is a schematic view of an operation flow of selecting the requests to be processed.

In Step S241, at least one of the requests to be processed is selected from the request queue.

In Step S242, it is determined whether the access addresses of the selected data access requests that are received and the access address of the current request are continuous addresses.

In Step S243, it is determined whether an access capacity of the merged request exceeds a block size of the block device after the current request and the request to be processed are merged.

In Step S244, the request is no longer merged if the access capacity of the merged request is larger than the block size of the block device.

The above selection process is based on the sequentially of the data access requests and the continuity of the access addresses. In other words, a writing sequence of the current request and the requests to be processed serves as a condition of the selection. Moreover, the access address of the current request and the access addresses of the requests to be processed are regarded as another set of selection conditions. The reason is that the data access requests sent by the client 110 are not intended to access the continuous addresses of the block devices 130. If each data access request has discontinuous access addresses, the access efficiency of the block device 130 is affected as the block device 130 accesses data at these access addresses by leaping. Further, in order to avoid that the amount of accessed data after the merge is greater than the block size of the block device 130, it is determined in Step S243 whether the access capacity of each merged request exceeds the block size of the block device 130.

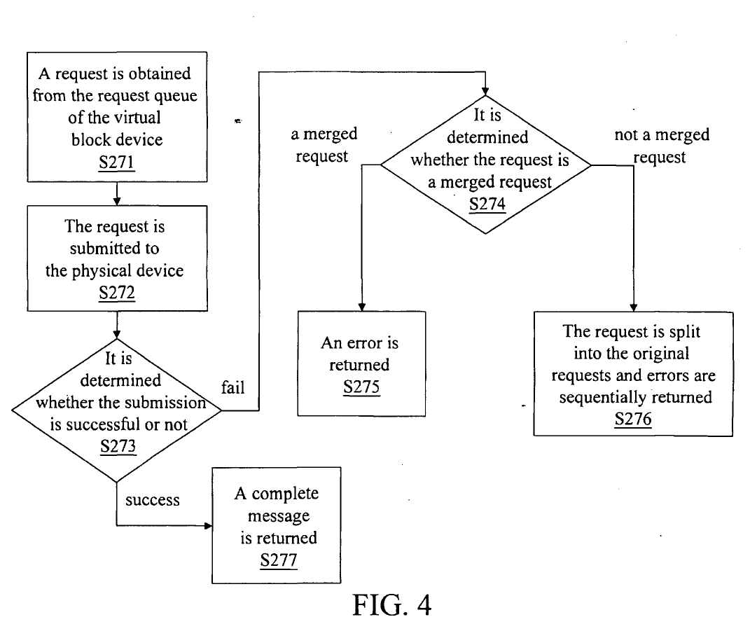

FIG. 4 is a schematic view of an operation flow of submitting a request of the virtual device to a physical block device. After completing each access operation above, a request of the virtual device is submitted to a physical device.

In Step S271, a request is obtained from the request queue of the virtual block device.

In Step S272, the request is submitted to the physical device.

In Step S273, it is determined whether the submission is successful.

In Step S274, it is determined whether the request is a merged request if the request submission fails.

In Step S275, if the request is a merged request, an error is returned.

In Step S276, if the request is not a merged request, the request is split into the original requests and errors are sequentially returned.

In Step S277, a complete message is returned if the request submission is successful.

To further illustrate the operation details of the present invention, the following program structure is illustrated together with the operation flow. First, a structure of a data access request is defined (based on linux2.6 kernel):

| struct v_request | | |
|---|---|---|
| { | | |
| struct list_headnode; | | a queue node, for being added to the |
| request queue | | |
| dev_t | dev; | a device number corresponding to the |
| request | | |
| loff_t | offset; | an initialized address of the request |
| on the device | | |
| size_t | size; | a size of the request |
| void | *ori_req; | an original request |
| struct mergeinfo | *minfo | merge information |
| end_req_t | *end_req; | a callback function |
| } | | |

A structure for recording the merge information:

| | | |
|---|---|---|
| struct mergeinfo | | |
| { | | |
| loff_t | offset; | a merged initialized address |
| size_t | size; | a merged size |
| struct iovec | *iov; | a merged data fragment |
| struct v_request | *mreq; | a merged request link list |
| } | | |

The prototype of a request callback function is defined as:
typedef void (end_req_t) (struct*v_request, unsigned int size, int result);
A block device is defined as:

| | | |
|---|---|---|
| struct v_device | | |
| { | | |
| dev_t | dev; | a device number |

| | | |
|---|---|---|
| make_request_fn | *new_make_request_fn | a new request |
| submission function | | |
| struct gendisk | *ori_device; | a destination device |
| make_request_fn | *ori_make_request_fn | an original request |
| submission function | | |
| spinlock_t | queue_lock; | a queue lock |
| struct list_head | req_queue; | a queue head |
| int | queue_len; | a queue length |
| int | queue_max_len; | the maximum |
| | | queue length |
| unsigned | bd_block_size; | a block size |
| } | | |

The process of receiving the current request from the client 110 is as follows.

In Step S210, a current request sent to the block device 130 is received. A v_request structure is configured for the current request. An index of the current request is stored in an ori_req member of the v_request structure. Meanwhile, a device identifier, initialized position, and size of the current request are stored in corresponding members of the v_request structure.

Next, a v_device device related to the block device 130 (i.e., the virtual device) is searched. If the device is not found, an access error is returned; otherwise, Step S230 is performed.

In Step S230, a request queue is obtained from the v_device device, and the last request to be processed in the request queue is obtained. It is calculated whether the request to be processed may be merged with the current request, and if yes, Step S250 is performed; otherwise, Step S260 is performed.

In Step S250, the request to be processed and the current request are merged into a merged request. Information such as the initialized address and size of the merged request is filled into a minfo member of the v_request structure, and Step S260 is performed.

In Step S260, the merged request is added into the request queue.

The process of submitting the current request is as follows.

Firstly, a first data access request is obtained from the request queue. The first data access request in the request queue means the data access request stored in the request queue for the longest time. Then, the data access request is submitted to the block device 130, and it is determined whether the minfo member of the data access request is null or not. If the minfo member is null, the data access request is not a merged request, and ori_make_request_fn of the v_device is invoked to submit the request; otherwise, the data access request is a merged request, and ori_make_request_fn is invoked for submission according to information in the minfo.

When the submission or request processing fails, if the data access request is not a merged request, an error is returned. Otherwise, the data access request is split into the original requests and errors are sequentially returned. During the split, information stored in the mreq queue in the minfo member is used.

In view of the above, an asynchronous processing method for data access requests is adapted to merge the data access requests for accessing the block device 130, such that the data access requests with continuous access addresses are merged into a single data access request, thereby enhancing the access efficiency of the block device 130.

What is claimed is:

1. A data access method for making an asynchronous request to a block device, adapted to access a block device in a server end and perform corresponding processing according to a plurality of data access requests, the method comprising:
receiving a current request from a client;
invoking a virtual device of the block device;
comparing the current request with a request queue storing a plurality of requests to be processed;
selecting the corresponding requests to be processed from the request queue according to an access address of the current request;
performing a request merging program on the requests to be processed with adjacent access addresses and the current request to generate a merged request; and
submitting the merged request to the request queue.

2. The data access method for making an asynchronous request to a block device according to claim 1, wherein the step of selecting the requests to be processed with adjacent access addresses further comprises:
selecting at least one of the requests to be processed from the request queue;
determining whether the access addresses of the selected data access requests that are received and the access address of the current request are continuous addresses; and
determining whether an access capacity of the merged request exceeds a block size of the block device after the current request and the requests to be processed are merged.

3. The data access method for making an asynchronous request to a block device according to claim 1, wherein the step of submitting the merged request to the request queue further comprises:
obtaining the request to be processed from the request queue; and
submitting the obtained request to be processed to the corresponding virtual device.

4. The data access method for making an asynchronous request to a block device according to claim 3, wherein before the step of submitting the received data access request, the method further comprises:
determining whether the request to be processed is the merged current request; and
restoring the request to be processed to the original current request if the request to be processed is the merged current request.
